(19) United States
(12) Patent Application Publication
(10) Pub. No.: US 2006/0015545 A1
(43) Pub. Date: Jan. 19, 2006

(54) Backup and sychronization of local data in a network

(76) Inventor: Josef Ezra, Ashland, MA (US)

Correspondence Address: THE ECLIPSE GROUP, 10605 BALBOA BLVD., SUITE 300, GRANADA HILLS, CA, 91344, US

(21) Appl. No.: 11/165,317

(22) Filed: Jun. 23, 2005

Related U.S. Application Data
(60) Provisional application No. 60/521,718, filed on Jun. 24, 2004.

(51) Int. Cl. G06F 12/00

(52) U.S. Cl. 707/204

(57) ABSTRACT

An approach to archiving data that enables a client to back-up files to a server that is assigned by a client and periodically verify the most recent versions of the files are present on the server or restore backed-up files from the server to a workstations where a client resides.

### RELATED APPLICATIONS

This Application claims priority to U.S. Provisional Patent Application No. 60/521,718 filed on Jun. 24, 2004 titled “A METHOD TO CREATE BACKUP FILES ON REMOTE SYSTEMS OVER THE NET”, by Josef Ezra, which a claim to priority is made and is incorporated by reference herein.

### BACKGROUND OF THE INVENTION

1. Field of the Invention

The present invention relates in general to backup and synchronization of data in a network, and more particularly to backup and synchronization of workstations to remote computers.

2. Related Art

It is not uncommon these days for households and small businesses to have computer networks with workstations, printers, and servers, or simple pier-to-pier mesh networks of computers. Workstations are computers that typically have an operating system, application programs, and data files located on a local storage device, such as at least one of a hard disk drive, floppy disk drive, optical drive, tape drive, or memory drive. This local storage device typically has electromagnetic parts and/or electronics that are susceptible to failures due to use and age of the storage device. Similarly, these storage devices are also susceptible to environmental damage from fire, water, electrical surges, and static electricity.

When damage or failure in a storage device occurs, it is commonly called a “crash” as in “a hard drive crash.” Upon a “crash”, data contained in the storage device is often partially or totally damaged and unrecoverable. But on a workstation in a network, only locally stored data is affected and possibly unrecoverable. This is because data often resides on the server and is only accessed by the workstation. Often local data is work in progress or other personal files and notes that the user of the workstation has saved. For example, a workstation may access a database that resides on the server to generate reports. But, a local storage device crash on the workstations has little impact on the data stored at the server.

Current approaches to backing up or saving data located on the local storage device include using tape backups, removable media, or mirrored storage devices to name but a few. Problems that occur with tape backups and removable media is that backup of the data only occurs at predetermined intervals with an added cost of hardware and storage media. Often small businesses and households rely on these periodic manual backup devices. Further, errors may occur in the data stored on the removable media, such as digital tapes. A problem with mirrored storage devices is the added cost and the backed up data is still present on the workstation that is susceptible to environmental damage.

Therefore it can be seen, then, that there is a need in the art for an approach to backing up and synchronizing data stored locally on a workstation.

### SUMMARY

Approaches consistent with the present invention provide files and subdirectories to be backed up and restored in a network making use of workstations and servers within the network. A workstation may have a client and/or backup server implemented in software. A controller assigns a client to a server and may function as a proxy for the server. The client has a database that contains a list of files and subdirectories that need to be backed up or restored and communicates across the network with a server where the backed-up files reside. The server also maintains a database of backed-up items that enables the client and server to periodically verity the all flies are update.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 is a network diagram of a workstation having data backed up and synchronized to a server.

FIG. 2 is a ladder diagram of messages between the workstation, server, and controller of FIG. 1.

FIG. 3 is a flow diagram of backup and synchronization of local data in the network of FIG. 1.

### DETAILED DESCRIPTION

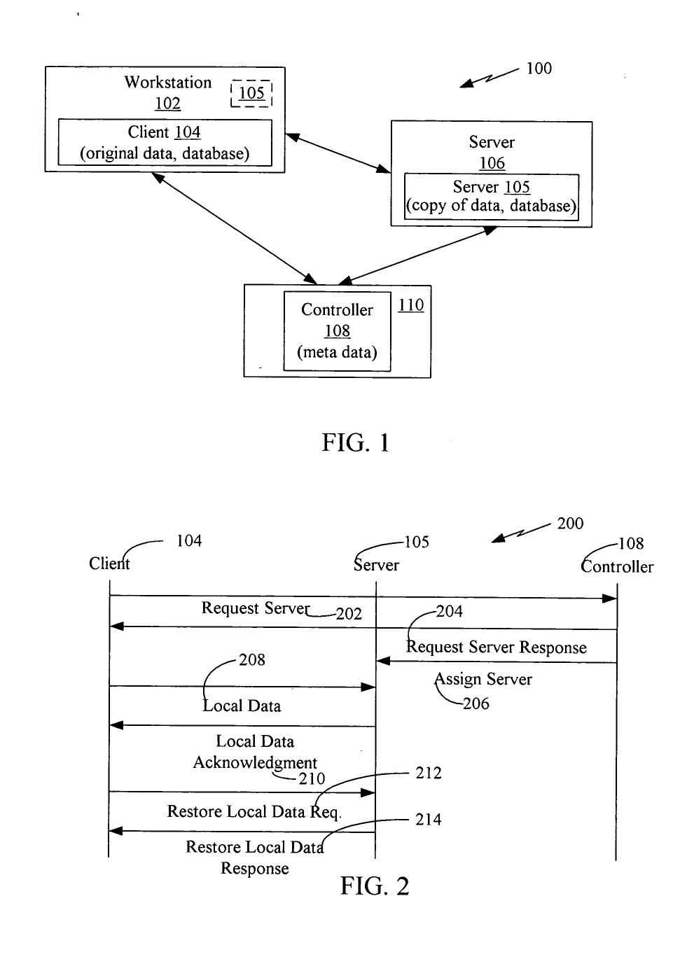

In FIG. 1, a network diagram 100 of a workstation having data backed up and synchronized to a server is shown. The network is shown with a workstation 102 that is in signal communication with a server 106 and a controller 108. The server 106 is also in signal communication with the controller 108. The signal communication may be via TCP/IP over wired Ethernet in the current implementation. In other implementations, the signal communication may be via wired network protocols, wireless protocols (802.11b, 802.11g, Bluetooth, cellular standards, etc. . . . ), or a combination of wired and wireless protocols.

The workstation 102 is executing software that implements a client 104 where local data is located that needs to be backed-up from, for example a personal computer with an operating system such as WIDOWS XP or OS9. The server 106 is executing software 105 that implements a backup server. The server 106 may be a network device such as a computer executes operating system software, such as Linux OS, WINDOWS SERVER 2003, to name but a few. The backup server 105 is a repository for backed up files via the client 104 on workstation 102. The controller 108 is software that is implemented on one or more computers 110 that may be workstations or servers, but correlates the communication between the client 104 at a workstation 102 and the server 106. In other implementations, the client 104 may be implemented in software that resides on the workstations 102 and the server portion 105 may be implemented in software that resides on another workstations (not shown) in one or more networks. Similarly, a workstation such as 102 may execute client and server software for implementing both the client 104 and the backup server 105 to backup local files in one or more remote workstations and may also store files from that workstation and other remote computers in the network.

The client 104 on workstation 102 and the backup server 105 may login or access the controller 108. The controller 108 identifies or registers the status of workstation 102 and server 105 as being online. In other words, the controller 108 maintains a list of servers connected by each client and the last connection timestamp, so the clients will be able to receive this information during restoration of local data from a server. The controller 108 communicates with the backup server 105 in order to notify the backup server 105 to listen and accept requests from the client 104.

The client 104 at workstation 102 may then connect to server 106 and backup local data to the server. If a connection from the client 104 to server 106 is not possible, then the controller 108 or a proxy in the network identified by the controller may buffer packets and forward them to the server 106 via the signal communication link between the controller 110 and the server 106. If no link is available, then the controller may buffer the local data from the workstation 102 until the backup server 105 becomes available. Thus, the controller 108 may function as a temporary server for workstation 102 and client 104. In other implementations the controller 108 may designate another workstation or server in the network to be a proxy for backup server 105. In another implementation where there are only a limited number of workstations and servers, such as in a home network, a user may configure the workstation 102, client 104, backup server 105, and controller 108 manually.

The client 104 may have a database that represents a state of the local data that needs to be backed-up or stored at the backup server 105. The client 104 monitors the database and file system of the workstation 102 and manages which local data (files and directories) is sent to the backup server 105. The local data to be sent to the backup server 105 may be compressed using known compression algorithms and or encrypted to save space and as added security. In the current implementation, the local data is sent with the additional information of original file name, full path name, and last change timestamps.

Local data is received at the backup server 105 and stored in a dedicated storage space. The local data stored at the backup server 105 is identified in a database located at the server 106 with the additional information and the sender's identification. Older versions of the local data (i.e. files and directories) received at the backup server 105 may be deleted or otherwise removed from the server. In other implementations, different versions of the local data may reside and be retrieved from the backup server 105.

Upon the database being updated with the additional information, the server 106 may send an acknowledgment message to the client 104 located on workstation 102. When client 104 receives the acknowledgment message, the database maintained by the client is updated with the additional information. In other implementations, the additional information may already be in the database located at the client 104 and a flag or bit being set in response to the acknowledgment message.

The database located at the client 104 may contain information such as:
General data: Server ID
General information: last connection timestamp
Key: file/directory name
Filter: wild characters and strings
Time: last change timestamp of last successful save
Encryption level: type of encryption
   The “Server ID” is used to identify the backup server 105 in the network that is storing the local data from workstation 102. The key is used to identify the file and directory. In other implementations, different types of identifies may be used. In addition to the key, a time filed is used to identify the version of the file/directory being stored.

The database maintained at the backup server 105 may contain the following information:
General data: Client ID
General information: last connection timestamp
Key: Original full filename
Copy filename: filename on server
ID number: A serial number allocated by server
Last Change Timestamp: Last change timestamp of file stored on server.
   The backup server 105 identifies the client 104 that the file is being received from with a client identifier (i.e. Client ID). The “Client ID” is stored in the database in addition to the time of communication with the client 104. The time of communication with the client is stored as the “last connection timestamp” in the database of the backup server 105. The original full file name is saved at the backup server 105 in order for the backup server 105 to rename files and received data, thus avoiding duplicate name issues. The Copy filename is the renamed file or data/pointer in a database, or any way that the backup server 105 may identify the client's data being stored at the backup server 105. Further, the server may generate a serial number based on a counter or algorithm to identify the record in the database. The server is able to identify if local data received from the client 104 is newer than a file already stored in the database by use of the last change timestamp. Similarly, the last change timestamp is used to verify if an older version of a file is being requested in a restore request. In one implementation, the client 104 and/or backup server 105 identification may be the unique name used to log into the controller 108, where the controller 108 provides the network identification of the client 104, server 106, and proxy when needed. In yet another implementation, the full filename may be encrypted by the client 104 with a unique key before being sent to the backup server 105 in order to increase security

The file monitoring process occurs in the client 104 at workstation 102. The client accesses the database and iterates through the entries. If an entry in the database is associated with a file, the timestamp of the actual file is checked. If the timestamp is not defined or is older than the files “last change” timestamp in the database, then the local data, i.e. file, is sent to the backup server 105. If a file is marked as “saved” does not exist on the client 104 (for example, after being erased by the user), a delete message may be sent to the backup server 105 from the client 104 according to a predefined policy. If for some reason, the local data cannot be sent, then reconnection to the server is attempted and the local data is sent again to the backup server 105 or cached at the controller 108. In the current implementation, the file monitoring process may occur when the computer, such as workstation 102 and server 106 are not loaded (processor is not being heavily utilized).

If the entry in the database at the client 104 is associated with a directory, each of the file or subdirectory in the directory that matches the filter and does not already exist in the database is added to the database. New local data, i.e. files and subdirectories may inherit the parent's directory's encryption level and filter, or a default one. After processing all local data in the subdirectory (including the newly added items), the client 104 processes may become idle for a predetermined time. In other implementations, the process may become idle until a predetermined event occurs, such as the workstation being powered on or an application is closed.

If local data at the workstation 102 needs to be sent from the client 104 to the backup server 105 it is encrypted according to the encryption level. The client 104 may have the local data compressed and encrypted to a temporary buffer located at the workstation 102. If the file is too big to be processed at the workstation 102 without affecting the workstation performance, the local data may be divided into multiple blocks with each block being processed.

When the backup server 105 receives the local data from the workstation 102, it is saved in its own file system in a dedicated area under a file identifier selected by the server 102. The database on the backup server 105 then is updated with the original file name, file identifier selected by the backup server 105, and the last change timestamp. In other implementations, the backup server 105 may save the data in a local database, such as mysql, BerklyDB, or any key data type data-store/data-structure.

Turning to FIG. 2, a ladder diagram 200 of messages between the client 104, server 105, and controller 108 of FIG. 1 is shown. The client 104 sends a “Request Server” message 202 to the controller 108. The controller 108 response with a Request Server Response message 204 to the client 104 and an “Assign Server” message 206 to server 106 notifying the server 106 of the assignment of the client 104.

The client 104 then may send local data via “Send Local Data” 208 message that contains the information about the local data being transferred. Upon completion of the local data being transferred from the workstation 102 to the backup server 105, the server then sends a “Local Data Acknowledgment” message 210. In some implementations, the “Send Local Data” message 208 may contain the actual local data being transferred from the client 104 to the backup server 105.

If the workstation 102 requires a file to be restored, the client 104 sends a “Restore Local Data Request” message 212 to the server. The backup server 105 responds with a “Restore Local Data Response” message 214 and also transfers the local data requested by the client 104. If the transfer fails, then the client 104 may request the local data again. After a predetermined number of attempts, the client will identify that the data will be unavailable. In another implementation, the backup server 105 may agree to send the data by a controller 108 acknowledging that the client 104 is in a ‘recover mode’ and restoring data.

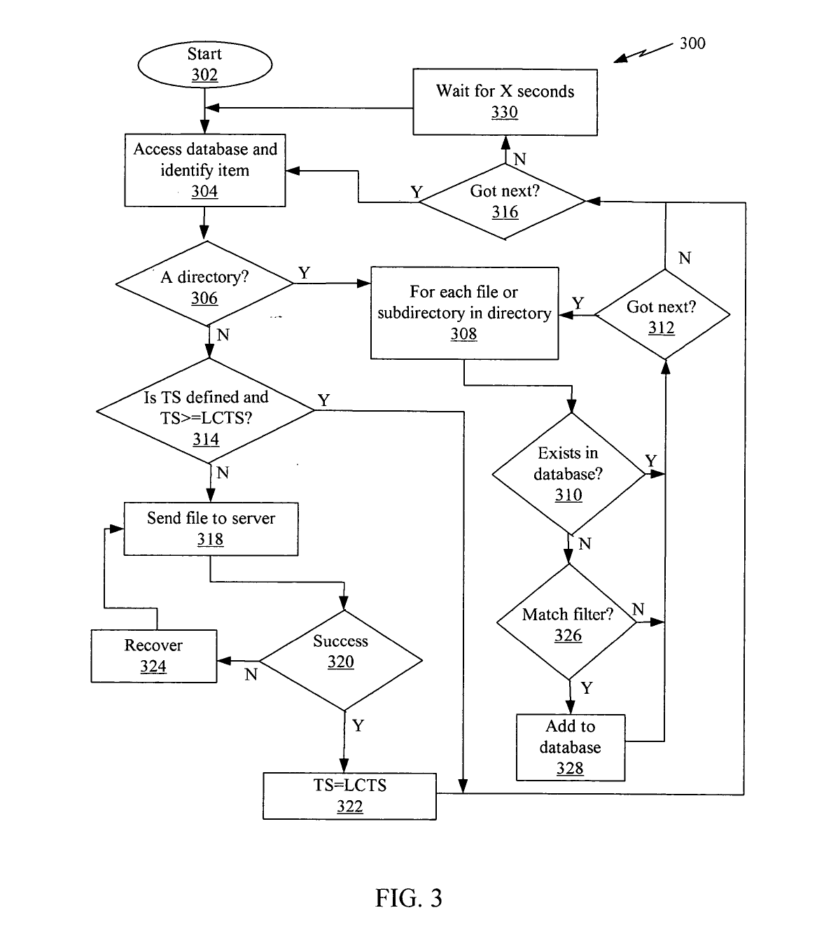

In FIG. 3, a flow diagram 300 of backup and synchronization of local data in the network of FIG. 1 is illustrated. The process starts 302 on a client 104 with the client 104 accessing the database and identifying items 304. If the item identified in step 0.304 is a directory 306 then each file or subdirectory in the directory 308 is check if it exists in the database 310 in the client 104. If it exist 312, then the next item is checked 308.

If the identified item is not a directory 306 then the time stamp is checked. If the time stamp of the item is greater than or equal to the last change time stamp 314 then the next item is retrieved 316. Otherwise, the local data (i.e. file) is sent to the server 318. If an acknowledgment is received from the server, then the transfer was successful 320 and the time stamp is set to the last change time stamp 322 and the next item is identified 304. If the local data was not successfully transferred in step 320, then recovery from the failure 324 is attempted and the local data is sent 318 again.

In step 310 a file or subdirectory does not exist, then a check is made to determine if it matches a filter that is associated with this subdirectory 326. If the file or subdirectory does match the filter 326, then it is added to the database 328 at the client 104 and the next file or subdirectory is check 312. Otherwise, the next file or subdirectory is checked 312.

If all items in the database at the client 104 have been checked 316 then a delay or wait period for a predetermined (i.e. “X” seconds) 330 is made. After delay 330, the database is again accessed and items in the database are synchronized 304. In other implementations, the delay period may vary according to system (i.e. computer) or network load and a predetermined priority of the file/directory being checked. In yet other implementations, steps may be eliminated and/or combined if the system supports interrupts or callbacks hooked to a file changes. In such cases, there may only be a single iteration to check the files/directory status and create those hooks.

The flow diagram may be implemented in software or hardware or a combination of software and hardware. The software may be presented on a signal-bearing medium that contains machine-readable instructions such as magnetic tape, compact disc, paper punch cards, smart cards, or other optical, magnetic, or electrical digital storage device.

The foregoing description of an implementation has been presented for purposes of illustration and description. It is not exhaustive and does not limit the claimed inventions to the precise form disclosed. Modifications and variations are possible in light of the above description or may be acquired from practicing the invention. For example, the described implementation includes software but the invention may be implemented as a combination of hardware and software or in hardware alone. Note also that the implementation may vary between systems. The claims and their equivalents define the scope of the invention.

What is claimed is:

1. A workstations, comprising:
a storage device having at least one file have a last change timestamp;
a network connection; and
a client executed by a processor able to communicate with the storage device and the network connection, where the client has access to a database that contains the last change timestamp when a determination is made if the at least one file is sent via the network connection to another workstations.

2. The workstation of claim 1, including
a message received at the network connection from a controller that identifies a server.

3. The workstation of claim 1, wherein the at least one file is encrypted prior to being sent.

4. The workstation of claim 1, including
an entry associated with the at least one file placed in the database upon selection of the at least one file for backup.

5. The workstation of claim 1, wherein the determination to send the at least one file occurs at predetermined intervals.

6. The workstation of claim 5, wherein the determination to send the at least one file is dependent upon loading of the workstation.

7. The workstation of claim 1, including
a restore request message that request restoration of the at least one file to the client where the restore request message request an identification of a backup server that has the at least one file to be restored.

8. The workstation of claim 7, wherein the at least one file to be restored is encrypted.

9. The workstation of claim 7, including
a message formatted with the identification of the backup server by the client for transmission to the backup server that request restoration of the at least one restore file.

10. The workstation of claim 1, including:
a message from a controller received at the network connection that identifies a backup server that the client will send backup files; and
a message sent in response to the message from the controller that is sent to the backup server.

11. A server, comprising:
a storage device with a database that identifies an at least one file associated with a last change timestamp from a client;
a processor coupled to the storage device;
a network connection coupled to the processor; and
a backup server executed by the processor able to communicate with the storage device and the network connection, where the backup server has access to the database and the at least one file.

12. The server of claim 11, wherein the at least one file is encrypted.

13. The server of claim 11, including:
a message that the backup server is in receipt of from a controller that contains a client identifier; and
an acknowledgment message formatted by the backup server for transmission by the network connection to a controller and a client identified by the client identifier.

14. A method of backing up a workstation, comprising:
storing in a storage device at least one file that has a last change timestamp;
executing a client program by a processor;
communicating with the storage device and a network connection, where the client has access to a database that contains the last change timestamp; and
determining if the at least one file is to be sent via the network connection to another workstations based upon the last change timestamp.

15. The method of backing up the workstation of claim 14, including
receiving a message at the network connection from a controller that identifies a server.

16. The method of backing up the workstation of claim 14, including
encrypting the at least one file prior to being sent.

17. The method of backing up the workstation of claim 14, including:
selecting the at least one file for backup; and
associating an entry in the database with the at least one file.

18. The method of backing up the workstation of claim 14, wherein the determination to send the at least one file occurs at predetermined intervals.

19. The method of backing up the workstation of claim 18, wherein the determination to send the at least one file is dependent upon loading of the workstation.

20. The method of backing up the workstation of claim 14, including
requesting restoration of the at least one file to the client with a restore request message, where the restore request message request an identification of a backup server that has the at least one file to be restored.

21. The method of backing up the workstation of claim 20, wherein the at least one file to be restored is encrypted.

22. The method of backing up the workstation of claim 20, including
formatting a message with the identification of the backup server by the client for transmission to the backup server that request restoration of the at least one file to be restored.

23. The method of backing up a workstation of claim 22, including:
receiving a message from a controller at the network connection that identifies a backup server that the client will send backup files; and
sending a server message in response to the message from the controller that is sent to the backup server.

24. A method of storing files at a backup server, comprising:
storing an at least one file associated with a last change timestamp in a storage device with a database; and
executing a backup server program by a processor that communicates with the storage device and a network connection where the backup server has access to the database and the at least one file.

25. The method of storing files at a backup server of claim 24, including
encrypting the at least one file is encrypted.

26. The method of storing files at a backup server of claim 24, including:
receiving a message at the backup server from a controller that contains a client identifier; and
transmitting an acknowledgment message formatted by the backup server by the network connection to a controller and a client identified by the client identifier.

27. A computer-readable medium containing instructions that cause a computer system to perform a method for backing up a workstation in a network, the method comprising the steps:
storing in a storage device at least one file that has a last change timestamp;
executing a client program by a processor;
communicating with the storage device and a network connection, where the client has access to a database that contains the last change timestamp; and
determining if the at least one file is to be sent via the network connection to another workstations based upon the last change timestamp.

28. The computer-readable medium containing instructions that cause a computer system to perform a method for backing up a workstation in a network, the method claim 27, including the step of
receiving a message at the network connection from a controller that identifies a server.

29. The computer-readable medium containing instructions that cause a computer system to perform a method for backing up a workstation in a network, the method of claim 27, including the step of
encrypting the at least one file prior to being sent.

30. The computer-readable medium containing instructions that cause a computer system to perform a method for backing up a workstation in a network, the method of claim 27, including the steps of:
selecting the at least one file for backup; and
associating an entry in the database with the at least one file.

31. The computer-readable medium containing instructions that cause a computer system to perform a method for backing up a workstation in a network, the method of claim 27, wherein the determination to send the at least one file occurs at predetermined intervals.

32. The computer-readable medium containing instructions that cause a computer system to perform a method for backing up a workstation in a network, the method of claim 31, wherein the determination to send the at least one file is dependent upon loading of the workstation.

33. The computer-readable medium containing instructions that cause a computer system to perform a method for backing up a workstation in a network, the method of claim 14, including the step of
requesting restoration of the at least one file to the client with a restore request message, where the restore request message request an identification of a backup server that has the at least one file to be restored.

34. The computer-readable medium containing instructions that cause a computer system to perform a method for backing up a workstation in a network, the method of claim 33 wherein the at least one file to be restored is encrypted.

35. The computer-readable medium containing instructions that cause a computer system to perform a method for backing up a workstation in a network, the method of claim 33, including the step of
formatting a message with the identification of the backup server by the client for transmission to the backup server that request restoration of the at least one file to be restored.

36. The computer-readable medium containing instructions that cause a computer system to perform a method for backing up a workstation in a network, the method of claim 35, including the steps of:
receiving a message from a controller at the network connection that identifies a backup server that the client will send backup files; and
sending a server message in response to the message from the controller that is sent to the backup server.

37. A computer-readable medium containing instructions that cause a computer system to perform a method of storing files at a backup server, the method comprising the steps of:
storing an at least one file associated with a last change timestamp in a storage device with a database; and
executing a backup server program by a processor that communicates with the storage device and a network connection where the backup server has access to the database and the at least one file.

38. The computer-readable medium containing instructions that cause a computer system to perform a method of storing files at a backup server, the method of claim 37 including the step of
encrypting the at least one file is encrypted.

39. The computer-readable medium containing instructions that cause a computer system to perform a method of storing files at a backup server, the method of claim 37, including the steps of:
receiving a message at the backup server from a controller that contains a client identifier; and
transmitting an acknowledgment message formatted by the backup server by the network connection to a controller and a client identified by the client identifier.
